(19) United States
(12) Patent Application Publication
(10) Pub. No.: US 2010/0270162 A1
(43) Pub. Date: Oct. 28, 2010

(54) Cationic electrodeposition coating composition

(75) Inventors: Shigeo Nishiguchi, Hiratsuka-shi (JP); Akihiko Shimasaki, Hiratsuka-shi (JP)

Correspondence Address: WENDEROTH, LIND & PONACK, L.L.P., 1030 15th Street, N.W.,, Suite 400 East, Washington, DC, 20005-1503, US

(73) Assignee: KANSAI PAINT CO., LTD.

(21) Appl. No.: 12/662,308

(22) Filed: Apr. 9, 2010

(30) Foreign Application Priority Data
Apr. 24, 2009 (JP) 2009-105914
Apr. 28, 2009 (JP) 2009-108879

(51) Int. Cl. B32B 15/092; C08G 59/14

(52) U.S. Cl. 205/50; 525/528

(57) ABSTRACT

An object of the present invention is to provide a coating composition that has excellent throwing power and electrodeposition coating applicability onto hot dip galvanized steel sheets, and that provides a cationic electrodeposition coating film having a superior finish and excellent anti-corrosion properties, and a multilayer coating film with a superior finish formed on the cationic electrodeposition coating film by a 3C1B process.

The present invention provides a cationic electrodeposition coating composition having amino group-containing epoxy resin (A) obtained by reacting epoxy resin (A1) having an epoxy equivalent of 500 to 2,500 with amine compound (A2); and blocked polyisocyanate curing agent (B).

### TECHNICAL FIELD

The present invention relates to a cationic electrodeposition coating composition that has excellent throwing power and electrodeposition coating applicability onto hot dip galvanized steel sheets, and that can provide a cationic electrodeposition coating film with excellent anti-corrosion properties and a superior finish, in particular, a superior finish at a dried film thickness of 15 μm, and a multilayer coating film with a superior finish formed on the cationic electrodeposition coating film by a 3-coat 1-bake process.

### BACKGROUND ART

Because of the excellent coating operability and good anti-corrosion properties of the resulting coating films, cationic electrodeposition coating compositions are widely used as undercoating compositions for conductive metal products, such as automobile bodies, which are required to have the aforementioned properties. However, to improve collision safety, automobile bodies with enhanced strength have recently been desired; therefore, reinforcing materials are further added to a material welded by spot welding, which results in an increased number of articles that contain complicated bag portions and gap portions.

This configuration, however, lowers the current density (mA/cm²) during electrodeposition coating, which makes the deposition of a coating film difficult, thereby preventing bag portions and gap portions from coating. Accordingly, anti-corrosion properties tend to be lowered.

Various changes in coating conditions are made to ensure the film thickness (μm) of bag portions and gap portions; however, coating a material by merely increasing the coating voltage during electrodeposition coating causes the opening of gap structures to close, making it difficult to impart throwing power to complicated bag portions and gap portions. Further, coating with an increased voltage causes other problems, such as lowering the “electrodeposition coating applicability onto hot dip galvanized steel sheets”, and increasing the outer film thickness (μm) of an article to be coated, thereby requiring the use of an increased amount of coating composition.

Furthermore, if a method for increasing the polarization resistance value of a coating composition is used to improve throwing power, the heat flow properties of the coating film will become poor, which tends to result in a coating film with a poor finish.

Some attempts are made to maintain the inner film thickness of bag portions and gap portions to ensure effective anti-corrosion properties, and to optimize or uniformize the outer film thickness (for example, to ensure the film thickness of a portion where a finish and anti-corrosion properties are valued) for improving the quality of automobile bodies and reducing the cost.

However, coating films obtained using conventional electrodeposition coating compositions have disadvantages such that a reduced film thickness results in a poor finish because of an uneven substrate or a reduction in heat flow properties, which further results in a poor finish of a multilayer coating film formed on the electrodeposition coating film. Additionally, anti-corrosion properties tend to be lowered.

Conventional automobile body coating methods include the steps of applying an electrodeposition coating composition, applying an intermediate coating composition on a baked and dried electrodeposition coating film, applying an aqueous colored coating composition followed by preheating, and applying a clear coating composition followed by baking and drying, thereby forming a multilayer coating film (a coating film formation method using a so-called “3C2B process”). By such baking, uneven coating films are made smooth, and a multilayer coating film with excellent anti-corrosion properties and a superior finish can be obtained.

However, if baking and drying are performed after the application of each coating composition, not only are significant energy costs needed for baking and drying but a significant amount of care and costs are required for the operation and maintenance of baking facilities. Further, in order to reduce the amount of low volatility organic compounds in a coating composition (reduction in VOC), more and more aqueous coating compositions are used in place of organic solvent-based coating compositions.

Furthermore, in order to reduce costs, the dried thickness of the electrodeposition coating film is reduced; however, if the film thickness, which has been 20 μm, is reduced to, for example, 15 μm, the finish of the electrodeposition coating film is deteriorated by an uneven substrate and a reduction in heat flow properties, which further results in the formation of a multilayer coating film with a poor finish on the electrodeposition coating film. Additionally, anti-corrosion properties tend to be lowered.

In order to save energy, omit processes, and reduce VOC, there has been a demand for the production of a multilayer coating film (hereinafter sometimes referred to as a “multilayer coating film obtained by a 3C1B process”) with excellent anti-corrosion properties and a superior finish, by a coating film formation method in which an aqueous first colored coating composition, an aqueous second colored coating composition, and a clear coating composition are sequentially applied to an electrodeposition coating film, and the three layers are simultaneously cured by heating.

In view of these circumstances, the development of a cationic electrodeposition coating composition that exhibits excellent throwing power in an article having complicated bag portions and gap portions, and electrodeposition coating applicability onto hot dip galvanized steel sheets, and that can provide a cationic electrodeposition coating film with excellent anti-corrosion properties and a superior finish, in particular, a superior finish at a dried film thickness of 15 μm, and a multilayer coating film having an excellent finish obtained by a 3C1B process has been desired.

Patent Literature 1 discloses a method for producing a coating film, the method being characterized in that, in the electrodeposition coating of a cationic electrodeposition coating composition, the electric quantity required for initiating the deposition of coating film is 100 to 400 C/m², and the polarization resistance value per unit film thickness is 50 to 300 kΩ·cm²/μm.

Patent Literature 2 discloses a multilayer coating film formation method in which a cationic electrodeposition coating composition is applied to a base material to form a cured electrodeposition coating film with a glass transition temperature of not less than 110° C. and a surface roughness (Ra) of not greater than 0.3 μm; an intermediate coating composition, a top coat base coating composition, and a top coat clear coating composition are sequentially applied to the surface of the electrodeposition coating film to form three coating films, i.e., an uncured intermediate coating film, an uncured top coat base coating film, and an uncured top coat clear coating film; and the three coating films are simultaneously cured by heating.

However, the methods disclosed in Patent Literatures 1 and 2 cannot provide an electrodeposition coating film with a satisfactory finish, particularly, finish at a dried film thickness of 15 μm, and a multilayer coating film having a satisfactory finish obtained by a 3C1B process.

### [Citation List]

[Patent Literature]

[PTL 1]

Japanese Unexamined Patent Publication No. 2003-306796

[PTL 2]

Japanese Unexamined Patent Publication No. 2002-224613

### SUMMARY OF INVENTION

### Technical Problem

An object of the present invention is to provide a coating composition that has excellent throwing power, and electrodeposition coating applicability onto hot dip galvanized steel sheets, and that provides a cationic electrodeposition coating film with an excellent finish, in particular, an excellent finish at a dried film thickness of 15 μm, and a multilayer coating film formed on the cationic electrodeposition coating film by a 3C1B process, the multilayer coating film having an excellent finish.

### Solution to Problem

To achieve the above object, the present inventors conducted extensive research. As a result, they found that the object can be achieved by a cationic electrodeposition coating composition comprising amino group-containing epoxy resin (A) obtained by reacting epoxy resin (A1) having an epoxy equivalent of 500 to 2,500 with specific amine compound (A2); and blocked polyisocyanate curing agent (B). The present invention was thus accomplished.

That is, the present invention provides as follows.

Item 1. A cationic electrodeposition coating composition comprising:

amino group-containing epoxy resin (A) obtained by reacting epoxy resin (A1) having an epoxy equivalent of 500 to 2,500 with amine compound (A2) represented by formula (I)

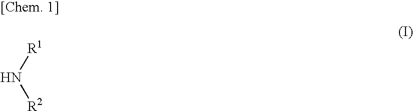

wherein R¹ represents a C₁₋₈ alkyl group, and R² represents a C₂₋₈ alkyl group optionally having at least one hydroxyl group; and

blocked polyisocyanate curing agent (B).

Item 2. The cationic electrodeposition coating composition according to Item 1, wherein, in the formula (I), R¹ represents a C₁₋₆ alkyl group, and R² represents a C₂₋₈ alkyl group having a hydroxyl group; or R¹ and R² are the same or different, and each represents a C₂₋₈ alkyl group.
Item 3. The cationic electrodeposition coating composition according to Item 1, wherein, in the formula (I), R¹ represents a C₁₋₆ alkyl group, and R² represents a C₂₋₈ alkyl group having a hydroxyl group.
Item 4. The cationic electrodeposition coating composition according to Item 1, wherein amino group-containing epoxy resin (A) is obtainable by reacting epoxy resin (A1) and amine compound (A2) at an equivalent ratio of (amino groups in amine compound (A2))/(epoxy groups in epoxy resin (A1)) being 0.6 to 0.95.
Item 5. The cationic electrodeposition coating composition according to any one of Items 1 to 3, wherein epoxy resin (A1) is obtainable by reacting (a11), (a12), and (a13) below:
said (a11) being compound (1) represented by formula (1)

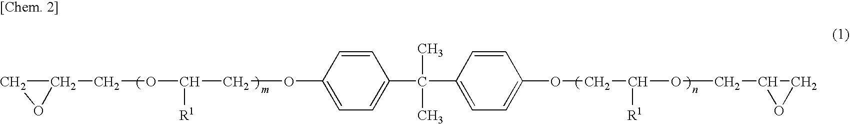

wherein R¹s are the same or different, and each represents a hydrogen atom or C₁₋₆ alkyl group; and m and n, which represent the number of repeating units of a portion having an alkylene oxide structure, are integers where m+n=1 to 20, and/or
compound (2) represented by formula (2)

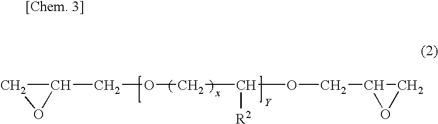

wherein R²s are the same or different, and each represents a hydrogen atom or C₁₋₆ alkyl group; X represents an integer of 1 to 9; and Y represents an integer of 1 to 50; said (a12) being an epoxy resin having an epoxy equivalent of 170 to 500; and
said (a13) being a bisphenol compound.
6. The cationic electrodeposition coating composition according to Item 5, wherein epoxy resin (A1) is obtainable by reacting 1 to 35 mass % of diepoxy compound (a11), 10 to 80 mass % of epoxy resin (a12), and 10 to 60 mass % of bisphenol compound (a13), based on the total solids mass of said diepoxy compound (a11), epoxy resin (a12), and bisphenol compound (a13).
7. The cationic electrodeposition coating composition according to Item 5 or 6, wherein diepoxy compound (a11) is a compound in which R¹ in formula (1) or (2) represents a methyl group or a hydrogen atom.
8. A coated article obtained by immersing a metal article containing an alloyed hot dip galvanized steel sheet in an electrodeposition bath containing the cationic electrodeposition coating composition according to Item 1, and performing electrodeposition coating.

### ADVANTAGEOUS EFFECTS OF INVENTION

The cationic electrodeposition coating composition of the present invention has excellent throwing power and electrodeposition coating applicability onto hot dip galvanized steel sheets, and can provide a coated article comprising a cationic electrodeposition coating film having excellent anti-corrosion properties and a superior finish, in particular, a superior finish at a dried film thickness of 15 μm, and a multilayer coating film formed on the cationic electrodeposition coating film by a 3C1B process, the multilayer coating film having an superior finish, for the following reasons.

1. Since hydrophobic amine compound (A2) is used in amino group-containing modified epoxy resin (A), it is easy for a coating film to deposit on bag portions at a low current density during electrodeposition coating (mA/cm²), resulting in good throwing power.

Further, since amine compound (A2) has a low hydrogen bonding strength, a deposition coating film comprising amino group-containing modified epoxy resin (A) has good heat flow properties during baking and drying, which provides a coating film with an excellent finish.

2. When diepoxy compound (a11) is used as a constituent component for amino group-containing modified epoxy resin (A), plasticity can be imparted to an epoxy resin skeleton, which improves electrodeposition coating applicability onto hot dip galvanized steel sheets and the smoothness of the cationic electrodeposition coating film. The finish of a multilayer coating film formed on the cationic electrodeposition coating film by a 3C1B process is also improved.

### BRIEF DESCRIPTION OF DRAWINGS

FIG. 1 shows a model structure that represents the “four-sheet box for throwing power evaluation” used in the throwing power evaluation.

FIG. 2 shows the condition of the electrodeposition coating in the throwing power evaluation.

### DESCRIPTION OF EMBODIMENTS

The cationic electrodeposition coating composition of the present invention comprises amino group-containing epoxy resin (A) obtained by reacting epoxy resin (A1) having an epoxy equivalent of 500 to 2,500 with amine compound (A2); and blocked polyisocyanate curing agent (B). The cationic electrodeposition coating composition of the present invention is detailed below.

### Amino Group-Containing Modified Epoxy Resin (A)

Amino group-containing modified epoxy resin (A) (In the specification, “amino group-containing modified epoxy resin (A) is sometimes referred to simply as “amino group-containing epoxy resin (A)) for use in the cationic electrodeposition coating composition of the present invention is a resin obtained by reacting epoxy resin (A1) having an epoxy equivalent of 500 to 2,500 with amine compound (A2).

### Epoxy Resin (A1) Having an Epoxy Equivalent of 500 to 2,500:

Epoxy resin (A1) having an epoxy equivalent of 500 to 2,500 is obtainable by reacting a polyphenol compound or a polyalcohol compound, with an epihalohydrin, such as epichlorohydrin. Of these, epoxy resins obtained by reacting a polyphenol compound and an epihalohydrin are preferable from the standpoint of corrosion resistance.

Examples of polyphenol compounds used for forming such epoxy resins include bis(4-hydroxyphenyl)-2,2-propane (bisphenol A), 4,4′-dihydroxybenzophenone, bis(4-hydroxyphenyl)methane (bisphenol F), bis(4-hydroxyphenyl)-1,1-ethane, bis(4-hydroxyphenyl)-1,1-isobutane, bis(4-hydroxy-tert-butyl-phenyl)-2,2-propane, bis(2-hydroxynaphthyl)methane, tetra(4-hydroxyphenyl)-1,1,2,2-ethane, 4,4′-dihydroxydiphenylsulfone (bisphenol S), phenol novolac, cresol novolac, etc.

Because amine compound (A2) is hydrophobic, the resulting amino group-containing modified epoxy resin (A) may have poor water dispersibility. Accordingly, from the standpoint of improving water dispersibility, it is particularly preferable to use resins obtained by reacting diepoxy compound (a11) containing compound (1) represented by formula (1) and/or compound (2) represented by formula (2), with epoxy resin (a12) having an epoxy equivalent of 170 to 500, and bisphenol compound (a13).

Diepoxy Compound (a11):

As diepoxy compound (a11), compound (1) represented by formula (1) can be used

### Compound (1)

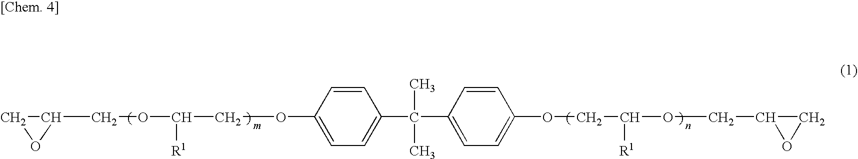

wherein R¹s are the same or different, and each represents a hydrogen atom or a C₁₋₆ alkyl group; m and n, which represent the number of repeating units of the portion having an alkylene oxide structure, are integers where m+n=1 to 20.

Compound (1) can be produced by adding alkylene oxide represented by formula (3) to bisphenol A to obtain a hydroxy-terminated polyether compound,

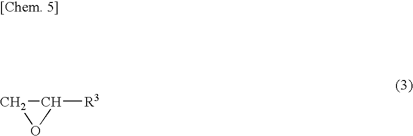

wherein R³ represents a hydrogen atom or a C₁₋₆ alkyl group, and then allowing the polyether compound to react with epihalohydrin to obtain a diepoxy compound.

Examples of alkylene oxide represented by formula (3) include ethylene oxide, propylene oxide, butylene oxide and like C₂₋₈ alkylene oxide.

Of these, ethylene oxide (compounds in which R³ in formula (3) is a hydrogen atom) and propylene oxide (compounds in which R³ in formula (3) is methyl) are preferable.

### Compound (2):

As diepoxy compound (a11), compound (2) represented by formula (2) can be used,

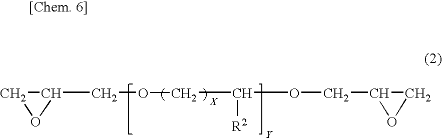

wherein R²s are the same or different, and each represents a hydrogen atom or a C₁₋₆ alkyl group; X is an integer of 1 to 9; and Y is an integer of 1 to 50.

Examples of the method for producing compound (2) include method (1) in which alkylene oxide represented by formula (3) is subjected to ring-opening polymerization using alkylene glycol as a starting material, thereby obtaining hydroxyl-terminated polyalkylene oxide, and the polyalkylene oxide is allowed to react with epihalohydrin to form a diepoxy compound.

Another example of the method for producing compound (2) includes method (2) in which alkylene glycol represented by formula (4), or polyether diol obtained by condensing two or more alkylene glycol molecules by dehydration, is allowed to react with epihalohydrin to form a diepoxy compound,

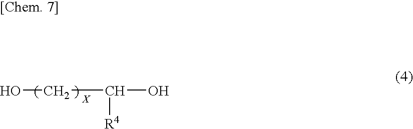

wherein R⁴ represents a hydrogen atom or a C₁₋₆ alkyl group, and X is an integer of 1 to 9.

Examples of alkylene glycol represented by formula (4) used herein include ethylene glycol, propylene glycol, trimethylene glycol, 1,4-butanediol, 1,3-butanediol, 1,5-pentanediol, 1,6-hexanediol, 1,8-octanediol and like C₂₋₁₀ alkylene glycol.

Examples of diepoxy compounds (a11) represented by formula (1) or formula (2) include Denacol EX-850, Denacol EX-821, Denacol EX-830, Denacol EX-841, Denacol EX-861, Denacol EX-941, Denacol EX-920, Denacol EX-931 (produced by Nagase Chemtex Corporation); Glyci-ale PP-300P and Glyci-ale BPP-350 (produced by Sanyo Chemical Industries, Ltd.), etc. As diepoxy compound (a11), compounds (1) and (2) may be used in combination.

Epoxy Resin (a12) Having an Epoxy Equivalent of 170 to 500:

Suitable epoxy resin (a12) for use in the production of epoxy resin (A1) having an epoxy equivalent of 500 to 2,500 is a compound having two or more epoxy groups per molecule. Examples of such compounds include those other than diepoxy compounds (a11), i.e., those other than compounds (1) represented by formula (1) and compounds (2) represented by formula (2). Suitable epoxy resin (a12) has a number average molecular weight of 340 to 1,500, and preferably 340 to 1,000, and an epoxy equivalent of 170 to 500, and preferably 170 to 400. In particular, epoxy resin (a12) obtained by reacting a polyphenol compound with epihalohydrin is preferable.

The “number average molecular weight” herein is a value determined according to the method of JIS K 0124-83, from a chromatogram measured by gel permeation chromatograph, based on the molecular weight of standard polystyrene. For a gel permeation chromatograph, “HLC8120GPC” (produced by Tosoh Corporation) was used. The measurement was conducted using four columns “TSK GEL G-4000HXL”, “TSK GEL G-3000HXL”, “TSK GEL G-2500HXL”, and “TSK GEL G-2000HXL” (trade names; produced by Tosoh Corporation) under the following conditions; mobile phase: tetrahydrofuran; measuring temperature: 40° C.; flow rate: 1.0 ml/min; and detector: RI.

Examples of polyphenol compounds used for forming such epoxy resins include bis(4-hydroxyphenyl)-2,2-propane (bisphenol A), bis(4-hydroxyphenyl)methane (bisphenol F), bis(4-hydroxycyclohexyl)methane (hydrogenated bisphenol F), 2,2-bis(4-hydroxycyclohexyl)propane (hydrogenated bisphenol A), 4,4′-dihydroxybenzophenone, bis(4-hydroxyphenyl)-1,1-ethane, bis(4-hydroxyphenyl)-1,1-isobutane, bis(4-hydroxy-2 or 3-tert-butyl-phenyl)-2,2-propane, bis(2-hydroxynaphthyl)methane, tetra(4-hydroxyphenyl)-1,1,2,2-ethane, 4,4′-dihydroxydiphenylsulfone, phenol novolac, cresol novolac, etc.

Of epoxy resins obtained by reacting a polyphenol compound with epichlorohydrin, those of the following formula (5) derived from bisphenol A are preferable,

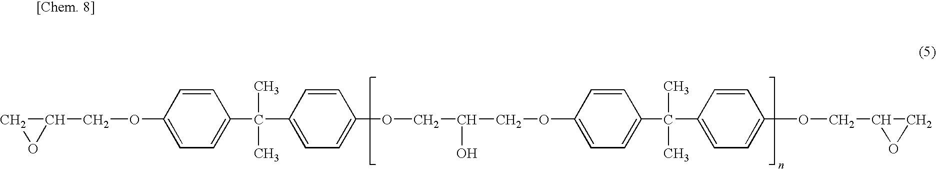

wherein n is preferably 0 to 2.

Examples of commercial products of such epoxy resins include those available from Japan Epoxy Resins Co., Ltd. under the trade names of jER828 EL and jER1001.

Bisphenol Compound (a13):

Examples of bisphenol compound (a13) include those represented by formula (6) below,

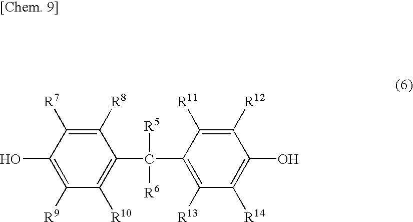

wherein R⁵ and R⁶ each represents a hydrogen atom or a C₁₋₆ alkyl group; and R⁷, R⁸, R⁹, R¹⁰, R¹¹, R¹², R¹³, and R¹⁴ each represents a hydrogen atom or a C₁₋₆ alkyl group.

Specific examples thereof include bis(4-hydroxyphenyl)-2,2-propane (bisphenol A) and bis(4-hydroxyphenyl)methane (bisphenol F).

In general, epoxy resin (A1) having an epoxy equivalent of 500 to 2,500 can be produced by mixing diepoxy compound (a11), epoxy resin (a12) having an epoxy equivalent of 170 to 500, and bisphenol compound (a13) to make these three compounds react in the presence of a suitably selected reaction catalyst such as dimethylbenzylamine, tributylamine and like tertiary amines; tetraethylammonium bromide, tetrabutylammonium bromide and like quaternary ammonium salts, at a reaction temperature of about 80° C. to 200° C., and preferably about 90° C. to 180° C., for 1 to 6 hours, and preferably 1 to 5 hours.

Examples of methods for producing epoxy resin (A1) are as follows (Methods 1 to 3).

1. A method in which diepoxy compound (a11), epoxy resin (a12) having an epoxy equivalent of 170 to 500, and bisphenol compound (a13) are all mixed and reacted with each other to produce epoxy resin (A1) having an epoxy equivalent of 500 to 2,500.
2. A method in which diepoxy compound (a11) and bisphenol compound (a13) are reacted to yield a reaction mixture, after which epoxy resin (a12) having an epoxy equivalent of 170 to 500 is added and reacted with the reaction mixture to produce epoxy resin (A1) having an epoxy equivalent of 500 to 2,500;
3. A method in which epoxy resin (a12) having an epoxy equivalent of 170 to 500 is reacted with bisphenol compound (a13) to yield a reaction mixture, after which diepoxy compound (a11) is added and reacted with the reaction mixture to produce epoxy resin (A1) having an epoxy equivalent of 500 to 2,500; etc. The reaction state can be traced by epoxy value.

In the production of epoxy resin (A1), the proportion of diepoxy compound (a11) is preferably 1 to 35 mass %, and more preferably 2 to 30 mass %, based on the total solids mass of the components for forming epoxy resin (A1), i.e., diepoxy compound (a11), epoxy resin (a12) having an epoxy equivalent of 170 to 500, and bisphenol compound (a13). The proportion in the above range is preferable to improve the water dispersibility of amino group-containing modified epoxy resin (A), and to improve the throwing power and the finish of a cationic electrodeposition coating film, in particular, the finish at a dried film thickness of 15 μm.

Further, to improve throwing power, the finish of a cationic electrodeposition coating film (in particular, the finish at a dried film thickness of 15 μm), electrodeposition coating applicability onto hot dip galvanized steel sheets, anti-corrosion properties, and the finish of a multilayer coating film obtained by a 3C1B process, it is preferable that the proportion of epoxy resin (a12) having an epoxy equivalent of 170 to 500 be 10 to 80 mass %, particularly 15 to 75 mass %, and the proportion of bisphenol compound (a13) be 10 to 60 mass %, particularly 15 to 50 mass %.

In the above production, an organic solvent may be optionally used. Examples thereof include toluene, xylene, cyclohexane, n-hexane and like hydrocarbons; methyl acetate, ethyl acetate, butyl acetate and like esters; acetone, methyl ethyl ketone, methyl isobutyl ketone, methyl amyl ketone and like ketones; dimethyl formamide, dimethyl acetamide and like amides; methanol, ethanol, n-propanol, isopropanol and like alcohols; phenylcarbinol, methylphenylcarbinol and like aromatic alkyl alcohols; ethylene glycol monobutyl ether, diethylene glycol monoethyl ether and like ether alcohol-based compounds; and mixtures thereof.

### Amine Compound (A2):

In the cationic electrodeposition coating composition of the present invention, amine compound (A2) represented by formula (1) is a cationic group-introducing component to cationize epoxy resin (A1) having an epoxy equivalent of 500 to 2,500. Amine compound (A2) can be represented by the following formula:

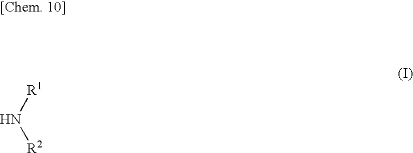

wherein R¹ represents a C₁₋₈ alkyl group, and R² represents a C₂₋₈ alkyl group optionally having at least one hydroxyl group.

In a preferable embodiment of the present invention, R¹ represents an alkyl group having 1 to 6 carbon atoms, preferably 1 to 4 carbon atoms, and more preferably 1 to 3 carbon atoms; and R² represents a C₂₋₈ alkyl group having a hydroxyl group, and preferably a C₂₋₄ alkyl group having a hydroxyl group.

Specifically, in the embodiment, the amine compound (A2) can be represented by the following formula:

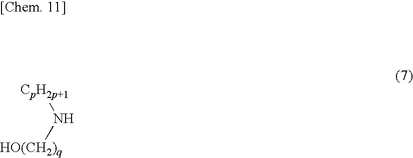

wherein p is an integer of 1 to 6, and q is an integer of 2 to 8.

Examples of the compound represented by formula (7) include 2-methylamino-1-ethanol, 2-ethylamino-1-ethanol, 2-isopropylamino-1-ethanol, 2-n-butylamino-1-ethanol, 2-hexylamino-1-ethanol, 3-methylamino-1-propanol, 3-ethylamino-1-propanol, 3-n-butylamino-1-propanol, 4-methylamino-1-butanol, 4-ethylamino-1-butanol, 4-n-butylamino-1-butanol, 4-n-hexylamino-1-butanol, 6-ethylamino-1-hexanol, 6-n-butylamino-1-hexanol, 8-ethylamino-1-octanol, etc.

Of these, 2-methylamino-1-ethanol, 4-ethylamino-1-butanol, and 2-ethylamino-1-ethanol are preferable to achieve the object of the present application.

In another preferable embodiment of the present invention, R¹ and R² are the same or different, and each represents a straight- or branched-alkyl group having 2 to 8 carbon atoms, preferably 2 to 4 carbon atoms. Specifically, in the embodiment, amine compound (A2) is dialkyl amine in which each of alkyl portions has 2 to 8 carbon atoms, and preferably 2 to 4 carbon atoms. Examples of the dialkyl amine include diethylamine, diisopropylamine, dibutylamine, diisobutylamine, dihexyl amine, dioctyl amine, N-ethyl propylamine, N-ethylisopropylamine, N-ethylhexyl amine, N-ethylisoallylamine, etc. Particularly preferable are diethylamine, diisopropylamine, dibutylamine, diisobutylamine, N-ethyl propylamine, etc.

Amino group-containing modified epoxy resin (A) used in the cationic electrodeposition coating composition of the present invention can be produced by subjecting epoxy resin (A1) having an epoxy equivalent of 500 to 2,500 to an addition reaction with amine compound (A2).

The proportion of each component used in the aforementioned addition reaction is not strictly limited, and can be suitably determined according to the use etc., of the electrodeposition coating composition. The proportion of epoxy resin (A1) is 75 to 98 mass %, preferably 78 to 96 mass %, and the proportion of amine compound (A2) is 2 to 25 mass %, preferably 4 to 22 mass %, based on the total solids mass of epoxy resin (A1) and amine compound (A2), which are used in the production of amino group-containing modified epoxy resin (A).

To obtain excellent throwing power, electrodeposition coating applicability onto hot dip galvanized steel sheets, and finish of the cationic electrodeposition coating composition, particularly, finish at a dried film thickness of 15 μm, the equivalent ratio of (amino groups in amine compound (A2))/(epoxy groups in epoxy resin (A1)) is 0.6 to 0.95, preferably 0.65 to 0.93, and more preferably 0.78 to 0.93.

The addition reaction is usually carried out in a suitable solvent at 80° C. to 170° C., and preferably 90° C. to 150° C. for 1 to 6 hours, and more preferably 1 to 5 hours. Examples of the solvent used in the above reaction include hydrocarbon solvents such as toluene, xylene, cyclohexane, n-hexane, etc.; ester solvents such as methyl acetate, ethyl acetate, butyl acetate, etc.; ketone solvents such as acetone, methyl ethyl ketone, methyl isobutyl ketone, methyl amyl ketone, etc.; amide solvents such as dimethylformamide, dimethylacetamide, etc.; alcohol solvents such as methanol, ethanol, n-propanol, iso-propanol, etc.; aromatic alkyl alcohols such as phenyl carbinol, methyl phenyl carbinol, etc.; ether alcohol compounds such as ethylene glycol monobutyl ether, diethylene glycol monoethyl ether, etc.; mixtures thereof; etc.

### Blocked Polyisocyanate Curing Agent (B)

When amino group-containing modified epoxy resin (A) for use in the cationic electrodeposition coating composition of the present invention is used in combination with blocked polyisocyanate curing agent (B), a heat-curable cationic electrodeposition coating composition can be produced.

Blocked polyisocyanate curing agent (B) is an almost stoichiometric amounts addition-reaction product of a polyisocyanate compound and an isocyanate blocking agent. Polyisocyanate compounds usable in blocked polyisocyanate curing agent (B) may be known compounds. Examples thereof include aromatic, aliphatic or alicyclic polyisocyanate compounds such as tolylene diisocyanate, xylylene diisocyanate, phenylene diisocyanate, diphenylmethane-2,2′-diisocyanate, diphenylmethane-2,4′-diisocyanate, diphenylmethane-4,4′-diisocyanate, crude MDI (polymethylene polyphenyl isocyanate), bis(isocyanatemethyl)cyclohexane, tetramethylene diisocyanate, hexamethylene diisocyanate, methylene diisocyanate, isophorone diisocyanate, etc.; cyclopolymers or biurets of these polyisocyanate compounds; and combinations thereof.

Specifically, tolylene diisocyanate, xylylene diisocyanate, phenylene diisocyanate, diphenylmethane-2,4′-diisocyanate, diphenylmethane-4,4′-diisocyanate, crude MDI, and like aromatic polisocyanate compounds are preferable in view of anti-corrosion properties.

The isocyanate blocking agent is added to isocyanate groups of a polyisocyanate compound to block the isocyanate groups. The blocked polyisocyanate compound obtained by such an addition is stable at room temperature; however, it is desirable that the blocking agent be dissociated to regenerate free isocyanate groups, when heated to the baking temperature of a coating film (usually about 100° C. to about 200° C.).

Examples of blocking agents usable in blocked polyisocyanate curing agent (B) include methylethylketoxime, cyclohexanone oxime and like oxime-based compounds; phenol, para-t-butylphenol, cresol and like phenol-based compounds; n-butanol, 2-ethylhexanol and like aliphatic alcohols; phenylcarbinol, methylphenylcarbinol and like aromatic alkyl alcohols; ethylene glycol monobutyl ether, diethylene glycol monoethyl ether and like ether alcohol-based compounds; ε-caprolactam, γ-butyrolactam and like lactam-based compounds; etc.

With regard to the cationic electrodeposition coating composition of the present invention, the proportion of amino group-containing modified epoxy resin (A) is 60 to 90 mass %, preferably 65 to 85 mass %, and the proportion of blocked polyisocyanate curing agent (B) is 10 to 40 mass %, preferably 15 to 35 mass %, based on the total solids mass of the components (A) and (B). The above proportions are preferable to achieve excellent coating composition stability, throwing power in a cationic electrodeposition coating composition, and electrodeposition coating applicability onto hot dip galvanized steel sheets, and to obtain a coated article that comprises a cationic electrodeposition coating film having excellent anti-corrosion properties and a superior finish, particularly, a superior finish at a film thickness of 15 μm, and a multilayer coating film having an excellent finish obtained by a 3C1B process.

In the production of a cationic electrodeposition coating composition containing amino group-containing modified epoxy resin (A) as a resin component, amino group-containing modified epoxy resin (A) and blocked polyisocyanate curing agent (B) are fully mixed, if necessary, with organic solvents and various additives, etc., such as surfactants, surface-adjusting agents, etc., to thereby prepare a preparation resin. The prepared preparation resin is rendered water-soluble or water-dispersible with organic carboxylic acid etc., to thereby obtain an emulsion.

The neutralization of the preparation resin may generally be performed using a known organic carboxylic acid; of these, acetic acid, formic acid, lactic acid, and mixtures thereof are preferable. Subsequently, a pigment dispersion paste is added to the emulsion, which is then adjusted using water to produce a cationic electrodeposition coating composition.

The above-mentioned pigment dispersion paste is a dispersion preliminarily comprising fine particles of a coloring pigment, a rust-preventive pigment, an extender pigment, etc., and may be prepared by, for example, mixing a resin for pigment dispersion, a neutralizer, a pigment, etc., and dispersing the resulting mixture in a dispersion mixer such as a ball mill, sand mill, pebble mill, or the like.

Known resins may be used as the above-mentioned resin for pigment dispersion. Examples thereof include base resins having hydroxyl and cationic groups; surfactants, etc.; and resins such as tertiary amine-type epoxy resins, quaternary ammonium salt-type epoxy resins, tertiary sulfonium salt-type epoxy resins, etc. The amount of the pigment dispersant used is preferably 1 to 150 parts by mass, particularly 10 to 100 parts by mass, per 100 parts by mass of the pigment and organic tin compound.

There is no particular limitation to the aforementioned pigment, and usable examples include coloring pigments such as titanium oxide, carbon black, colcothar, etc.; extender pigments such as clay, mica, baryta, calcium carbonate, silica, etc.; and rust-preventive pigments such as aluminum phosphomolybdate, aluminum tripolyphosphate, zinc oxide (zinc white), etc.

In order to inhibit corrosion or prevent rust, bismuth compounds may be used. Examples thereof include bismuth oxide, bismuth hydroxide, basic bismuth carbonate, bismuth nitrate, bismuth silicate, organic acid bismuth, etc.

In order to improve the curability of the coating films, organic tin compounds, such as dibutyltin dibenzoate, dioctyltin oxide, dibutyltin oxide, etc., may be used. However, in place of these organic tin compounds, rust-preventive pigments and/or bismuth compounds such as the above-mentioned zinc oxide (zinc white), etc., may also be used (in an increased amount), and/or refined for use, in order to improve the curability of the coating films. The amount of the pigments used is preferably 1 to 100 parts by mass, particularly 10 to 50 parts by mass, per 100 parts by mass of the total solids of the base resin and the curing agent.

Examples of articles on which the cationic electrodeposition coating composition of the present invention is to be coated include automobile bodies, parts for two-wheeled vehicles, home appliances, other appliances, etc. Articles are not particularly limited as long as they are made of metal.

Examples of metal steel sheets to be coated include cold-rolled steel sheets, hot dip galvanized steel sheets, electro-galvanized steel sheets, electrolytic zinc-iron duplex plated steel sheets, organic composite plated steel sheets, aluminium substrates, magnesium substrates, and the like. If necessary, these metal sheets may be washed using alkali degreasing etc., and subjected to surface treatment such as phosphate chemical conversion treatment, chromate treatment, etc.

The cationic electrodeposition coating composition may be applied on a desired substrate surface by electrodeposition coating. Cationic electrodeposition coating is generally performed by adjusting the temperature of an electrodeposition bath to 15 to 35° C., and applying a current at a load voltage of 100 to 400V using a to-be-coated article as a cathode. The electrodeposition bath comprises an electrodeposition coating composition diluted with deionized water or the like to a solids content of about 5 to about 40 mass %, and whose pH has been adjusted to 5.5 to 9.0. In general, after electrodeposition coating, the article is fully washed with ultrafiltrate (UF filtrate), reverse osmosis water (RO water), industrial water, deionized water or the like, to remove the cationic electrodeposition coating composition excessively adhered to the coated object.

The thickness of the electrodeposition coated film is not particularly limited, but is generally 5 to 40 μm, and preferably 12 to 30 μm, based on the thickness of the dried coating film. The baking and drying of the coating film is performed by heating the electrodeposition coating film at a surface temperature of the coated article of 110° C. to 200° C., preferably 140° C. to 180° C. for 10 to 180 minutes, preferably 20 to 50 minutes by means of a dryer such as an electric hot-air dryer, gas hot-air dryer or the like. By such baking and drying, a cured coating film is obtained.

The cationic electrodeposition coating film obtained by baking and drying as above has a center line mean roughness (Ra) of 0.20 μm or less, preferably 0.05 to 0.18 μm (at a cut off of 0.8 mm) at a dried film thickness of 15 μm, and has excellent finish. The center line mean roughness (Ra) in the roughness curve is defined by JIS B 601.

Further, by applying an aqueous first colored coating composition, an aqueous second colored coating composition, and a clear coating composition on the cured cationic electrodeposition coating film, and simultaneously drying the three layers of uncured coating films by heating (3C1B process), an article comprising a multilayer coating film with an excellent finish can be obtained.

### EXAMPLES

The present invention is explained in detail below with reference to the production examples, examples, and comparative examples; however, the present invention is not limited thereto. In the examples, “parts” “and “%” are by mass.

### Production of Amino Group-Containing Modified Epoxy Resin (A)

### Production Example 1

### Production Example of Base Resin No. 1

A 2-liter flask equipped with a thermometer, a reflux condenser, and a stirrer was charged with 162 parts of Glyci-ale PP-300P (Note 1), 1,000 parts of jER828 EL (Note 3), 440 parts of bisphenol A, and 1.6 parts of tetrabutylammonium bromide. The mixture was allowed to react at 160° C. until the epoxy equivalent became 800.

Next, 430 parts of methyl isobutyl ketone, and 130 parts of 2-methylamino-1-ethanol were added to the mixture, and then allowed to react at 100° C. for 4 hours. The solution of base resin No. 1, which was an amino group-containing modified epoxy resin with a resin solids content of 80% was thus obtained.

The proportion of diepoxy compound (a11) to the components of epoxy resin (A1) was 10 mass %, and the equivalent ratio of ([amino groups in amine compound (A2)]/[epoxy groups in epoxy resin (A1)])=0.9. The resulting base resin No. 1 had an amine value of 58 mg KOH/g, and a number average molecular weight of 2,200.

### Production Example 2

### Production Example of Base Resin No. 2

A 2-liter flask equipped with a thermometer, a reflux condenser, and a stirrer was charged with 162 parts of Glyci-ale PP-300P (Note 1), 1,000 parts of jER828 EL (Note 3), 440 parts of bisphenol A, and 1.6 parts of tetrabutylammonium bromide. The mixture was allowed to react at 160° C. until the epoxy equivalent became 800.

Next, 450 parts of methyl isobutyl ketone, and 210 parts of 4-ethylamino-1-butanol were added to the mixture, and then allowed to react at 100° C. for 4 hours. The solution of base resin No. 2, which was an amino group-containing modified epoxy resin with a resin solids content of 80% was thus obtained.

The proportion of diepoxy compound (a11) to the components of epoxy resin (A1) was 10 mass %, and the equivalent ratio of ([amino groups in amine compound (A2)]/[epoxy groups in epoxy resin (A1)])=0.9. The resulting base resin No. 2 had an amine value of 56 mg KOH/g, and a number average molecular weight of 2,200.

### Production Example 3

### Production Example of Base Resin No. 3

A 2-liter flask equipped with a thermometer, a reflux condenser, and a stirrer was charged with 162 parts of Glyci-ale PP-300P (Note 1), 1,000 parts of jER828 EL (Note 3), 440 parts of bisphenol A, and 1.6 parts of tetrabutylammonium bromide. The mixture was allowed to react at 160° C. until the epoxy equivalent became 800.

Next, 440 parts of methyl isobutyl ketone, and 158 parts of 2-ethylamino-1-ethanol were added to the mixture, and then allowed to react at 100° C. for 4 hours. The solution of base resin No. 3, which was an amino group-containing modified epoxy resin with a resin solids content of 80% was thus obtained.

The proportion of diepoxy compound (a11) to the components of epoxy resin (A1) was 10 mass %, and the equivalent ratio of ([amino groups in amine compound (A2)]/[epoxy groups in epoxy resin (A1)])=0.88. The resulting base resin No. 3 had an amine value of 56 mg KOH/g, and a number average molecular weight of 2,200.

### Production Example 4

### Production Example of Base Resin No. 4

340 parts of Glyci-ale BPP-350 (Note 2), 950 parts of jER828 EL (Note 4), 456 parts of bisphenol A, and 1.7 parts of tetrabutylammonium bromide were inserted into a 2-liter flask equipped with a thermometer, a reflux condenser, and a stirrer. The mixture was allowed to react at 160° C. until the epoxy equivalent became 875.

Next, 469 parts of methyl isobutyl ketone, and 130 parts of 2-methylamino-1-ethanol were added to the mixture, and then allowed to react at 100° C. for 4 hours. The solution of base resin No. 4, which was an amino group-containing modified epoxy resin with a resin solids content of 80% was thus obtained.

The proportion of diepoxy compound (a11) to the components of epoxy resin (A1) was 19 mass %, and the equivalent ratio of ([amino groups in amine compound (A2)]/[epoxy groups in epoxy resin (A1)])=0.9. The resulting base resin No. 4 had an amine value of 54 mg KOH/g, and a number average molecular weight of 2,400.

### Production Example 5

### Production Example of Base Resin No. 5

A 2-liter flask equipped with a thermometer, a reflux condenser, and a stirrer was charged with 162 parts of Glyci-ale PP-300P (Note 1), 1,000 parts of jER828 EL (Note 3), 440 parts of bisphenol A, and 1.6 parts of tetrabutylammonium bromide. The mixture was allowed to react at 160° C. until the epoxy equivalent became 800.

Next, 400 parts of methyl isobutyl ketone, 158 parts of diethanol amine, and 64 parts of a ketimine of diethylenetriamine with methyl isobutyl ketone (purity: 84%, methyl isobutyl ketone solution) were added to the mixture, and then allowed to react at 120° C. for 4 hours. The solution of base resin No. 5, which was an amino group-containing modified epoxy resin with a resin solids content of 80%, was thus obtained. Base resin No. 5 had an amine value of 60 mg KOH/g, and a number average molecular weight of 2,300. The proportion of diepoxy compound (a11) to the components of epoxy resin (A1) was 10 mass %.

Table 1 shows the formulations and the characteristic values of base resins Nos. 1 to 5 obtained in Production Examples 1 to 5.

TABLE 1

| | | | | Production | Production | Production | Production | Production |
|---|---|---|---|---|---|---|---|---|
| | | | | Example 1 | Example 2 | Example 3 | Example 4 | Example 5 |
| Base resin | | | | No. 1 | No. 2 | No. 3 | No. 4 | No. 5 |
| Formulation | (A1) | (a11) | Glyci-ale | 162 | 162 | 162 | | 162 |
| | | | PP-300P (Note 1) | | | | | |
| | | | Glyci-ale | | | | 340 | |
| | | | BPP-350 (Note 2) | | | | | |
| | | (a12) | jER828EL (Note 3) | 1000 | 1000 | 1000 | 950 | 1000 |
| | | (a13) | Bisphenol A | 440 | 440 | 440 | 456 | 440 |
| | | Catalyst | Tetrabutylammonium | 1.6 | 1.6 | 1.6 | 1.7 | 1.6 |
| | | | bromide | | | | | |
| | | Solvent | Methyl isobutyl | 430 | 450 | 440 | 469 | 400 |
| | | | ketone | | | | | |

| Amine compound | 2-Methylamino-1- | 130 | | | 130 | |
|---|---|---|---|---|---|---|
| (A2) | ethanol | | | | | |
| | 4-Ethylamino-1- | | 210 | | | |
| | butanol | | | | | |
| | 2-Ethylamino-1- | | | 158 | | |
| | ethanol | | | | | |
| Other amine | Diethanol amine | | | | | 158 |
| compound | Ketimine of | | | | | 64 |
| | diethylenetriamine | | | | | |
| | with methyl | | | | | |
| | isobutyl ketone | | | | | |

| | | | | | | |
|---|---|---|---|---|---|---|
| | Proportion of diepoxy compound (a11) to | 10.0 | 10.0 | 10.0 | 19.0 | 10.0 |
| | components | | | | | |
| | equivalent ratio of (amino groups in | 0.90 | 0.90 | 0.88 | 0.90 | — |
| | amine compound (A2))/(epoxy groups in | | | | | |
| | epoxy resin (A1)) | | | | | |
| Characteristic | Amine value (mg KOH/g) | 58.0 | 56.0 | 56.0 | 54.0 | 60.0 |
| value | Number average molecular weight | 2200 | 2200 | 2200 | 2400 | 2300 |

The numerals in the formulations are by parts.

(Note 1) Glyci-ale PP-300P: trade name of an epoxy resin (diepoxy compound (a11)) produced by Sanyo Chemical Industries, Ltd.; epoxy equivalent: 296; corresponding to compound (2).
(Note 2) Glyci-ale BPP-350: trade name of an epoxy resin (diepoxy compound (a11)) produced by Sanyo Chemical Industries, Ltd.; epoxy equivalent: 340; corresponding to compound (1).
(Note 3) jER828EL: trade name of an epoxy resin (a12) produced by Japan Epoxy Resins; epoxy equivalent: 190; number average molecular weight: 380

### Synthesis Example 1

### Production of Xylene-Formaldehyde Resin

480 parts of 50% formalin, 110 parts of phenol, 202 parts of 98% industrial sulfuric acid, and 424 parts of m-xylene were inserted into a 2-liter separable flask equipped with a thermometer, a reflux condenser, and a stirrer. The resulting mixture was allowed to react at 84° C. to 88° C. for 4 hours. After completion of the reaction, the reaction mixture was allowed to stand to separate a resin phase and a sulfuric acid aqueous phase. After the resin phase was washed with water 3 times, unreacted m-xylene was removed under the conditions of 20 to 30 mmHg and 120° C. to 130° C. for 20 minutes. As a result, 480 parts of a phenol-modified xylene-formaldehyde resin having a viscosity of 1,050 mPa·s (25° C.) was obtained.

### Production Example 6

### Production Example of Base Resin No. 6

A flask was charged with 1,140 parts of jER828 EL (Note 3), 456 parts of bisphenol A, and 0.2 parts of dimethylbenzylamine. The mixture was allowed to react at 130° C. until the epoxy equivalent became 820.

Next, 420 parts of methylisobutylketone, 300 parts of the xylene-formaldehyde resin obtained in Synthesis Example 1, 95 parts of diethanol amine, and 127 parts of a ketimine of diethylenetriamine with methyl isobutyl ketone (purity: 84%, methyl isobutyl ketone solution) were added to the mixture, and then allowed to react at 120° C. for 4 hours. The solution of base resin No. 6, which was an amino group-containing modified epoxy resin with a resin solids content of 80% was thus obtained. Base resin No. 6 had an amine value of 47 mg KOH/g, and a number average molecular weight of 2,500.

### Production of Blocked Polyisocyanate Curing Agent (B)

### Production Example 7

### Production Example of Curing Agent

270 parts of Cosmonate M-200 (trade name of crude MDI produced by Mitsui Chemicals, Inc.) and 127 parts of methyl isobutyl ketone were added to a reaction vessel and heated to 70° C. 236 parts of ethylene glycol monobutyl ether was added thereto dropwise over 1 hour, and the mixture was heated to 100° C. The mixture was sampled over time while the temperature was maintained; when no absorption by unreacted isocyanate groups was observed by infrared absorption spectrometry, the curing agent with a resin solids content of 80% was obtained.

### Production of Emulsion

### Production Example 8

### Production Example of Emulsion No. 1

87.5 parts (solids content: 70 parts) of base resin No. 1 obtained in Production Example 1 was mixed with 37.5 parts (solids content: 30 parts) of the curing agent obtained in Production Example 7. 13 parts of 10% acetic acid was added thereto and uniformly stirred. Thereafter, 156 parts of deionized water was added dropwise over about 15 minutes with vigorous stirring to thereby obtain emulsion No. 1 with a solids content of 34%.

### Production Examples 9 to 13

### Production Examples of Emulsions Nos. 2 to 6

Emulsions Nos. 2 to 6 were obtained in the same manner as in Production Example 8, except that the formulations shown in Table 2 were used.

TABLE 2

| | | Production | Production | Production | Production | Production | Production |
|---|---|---|---|---|---|---|---|
| | | Example 8 | Example 9 | Example 10 | Example 11 | Example 12 | Example 13 |
| Emulsion | | No. 1 | No. 2 | No. 3 | No. 4 | No. 5 | No. 6 |
| Formulation | Base | 87.5 (70.0) | | | | | |
| | resin | | | | | | |
| | No. 1 | | | | | | |
| | Base | | 87.5 (70.0) | | | | |
| | resin | | | | | | |
| | No. 2 | | | | | | |
| | Base | | | 87.5 (70.0) | | | |
| | resin | | | | | | |
| | No. 3 | | | | | | |
| | Base | | | | 87.5 (70.0) | | |
| | resin | | | | | | |
| | No. 4 | | | | | | |
| | Base | | | | | 87.5 (70.0) | |
| | resin | | | | | | |
| | No. 5 | | | | | | |
| | Base | | | | | | 87.5 (70.0) |
| | resin | | | | | | |
| | No. 6 | | | | | | |
| | Curing | 37.5 (30.0) | 37.5 (30.0) | 37.5 (30.0) | 37.5 (30.0) | 37.5 (30.0) | 37.5 (30.0) |
| | agent | | | | | | |
| | 10% | 13 | 13 | 13 | 13 | 13 | 13 |
| | acetic | | | | | | |
| | acid | | | | | | |
| | Deionized | 156.0 | 156.0 | 156.0 | 156.0 | 156.0 | 156.0 |
| | water | | | | | | |

| | | | | | | |
|---|---|---|---|---|---|---|
| Emulsion | 294.0 (100.0) | 294.0 (100.0) | 294.0 (100.0) | 294.0 (100.0) | 294.0 (100.0) | 294.0 (100.0) |

The parenthesized numerals in the formulations denote the solids content.

### Production Example 14

### Production Example of Resin for Pigment Dispersion

1,010 parts of jER828EL (See Note 3) was blended with 390 parts of bisphenol A, 240 parts of PLACCEL 212 (trade name of polycaprolactonediol produced by Daicel Chemical Industries; weight average molecular weight: about 1,250) and 0.2 parts of dimethylbenzylamine, and the mixture was allowed to react at 130° C. until the epoxy equivalent became about 1,090.

Next, 134 parts of dimethylethanolamine and 150 parts of a 90% aqueous lactic acid solution were added to the mixture, and then allowed to react at 120° C. for 4 hours. Methyl isobutyl ketone was subsequently added to adjust the solids content, thereby obtaining an ammonium salt-type resin for pigment dispersion having a solids content of 60%. The ammonium salt-type resin for pigment dispersion had an ammonium salt concentration of 0.78 mmol/g.

### Production Example 15

### Production Example of Pigment Dispersion Paste

8.3 parts (solids content: 5 parts) of the resin for pigment dispersion having a solids content of 60% obtained in Production Example 14, 14.5 parts of titanium oxide, 7.0 parts of refined clay, 0.3 parts of carbon black, 1 part of dioctyltin oxide, 1 part of bismuth hydroxide, and 20.3 parts of deionized water were added into a ball mill and dispersed for 20 hours. The pigment dispersion paste with a solids content of 55% was thus obtained.

### Production of an Aqueous First Colored Coating Composition

### Production Example 16

### Production of Polyester Resin Solution (PE1)

A reaction vessel equipped with a thermometer, a thermostat, a stirrer, a reflux condenser, and a water separator was charged with 88 parts of adipic acid, 536 parts of 1,2-cyclohexanedicarboxylic acid anhydride, 199 parts of isophthalic acid, 288 parts of 2-butyl-2-ethyl-1,3-propanediol, 95 parts of neopentyl-glycol, 173 parts of 1,4-cyclohexane dimethanol, and 287 parts of trimethylolpropane. After the resulting mixture was heated from 160° C. to 230° C. over a period of 3 hours, the condensed water was distilled off using the water separator while keeping the temperature at 230° C. The mixture was allowed to react until the acid value became 5 mg KOH/g or less.

86 parts of trimellitic anhydride was added to the reaction product, and an addition reaction was performed at 170° C. for 30 minutes. Subsequently, the resultant was cooled to 50° C. or less, and neutralized by adding 0.9 equivalents of 2-(dimethylamino)ethanol per equivalent of acid group. By gradually adding deionized water, a polyester resin solution (PE1) having a solids content of 45% was obtained. The resulting polyester resin (PE1) had an average molecular weight of 2,050, a hydroxyl value of 110 mg KOH/g, and an acid value of 33.0 mg KOH/g.

### Production Example 17

### Production of Aqueous First Colored Coating Composition

One part of Carbon MA100 (carbon black produced by Mitsubishi Chemical Corporation), 70 parts of JR806 (titanium white produced by Tayca Corporation), and 10 parts of MICRO ACE S-3 (fine powder talc, produced by Nippon Talc Co., Ltd.) were sequentially added to 37.5 parts of a resin for pigment dispersion (Note 4). The mixture was dispersed using a paint shaker for 30 minutes to obtain a pigment dispersion paste.

While stirring 118.5 parts of the resulting pigment dispersion paste, 114.6 parts (solids content: 55 parts) of polyester resin (PE1) obtained in Production Example 16, 37.5 parts (solids content: 30 parts) of melamine resin MF-1 (a methoxy/butoxy mixed alkylated melamine resin, solids content: 80%) and 7 parts of “n-butylalcohol” were sequentially added. Further, deionized water and dimethylethanolamine were added thereto to obtain an aqueous first colored coating composition having a pH of 8.5, and a viscosity of 40 seconds as measured by Ford cup No. 4 at 20° C.

(Note 4) Resin for pigment dispersion: a resin for pigment dispersion with a solids content of 40%, obtained by reacting monomers consisting of 30.4 parts of Cardura E10P (a glycidyl ester of synthetic highly branched saturated fatty acid produced by Hexion Specialty Chemicals), 41.5 parts of trimethylolpropane, 80.7 parts of anhydrous isophthalic acid, 79.9 parts of adipic acid, 83.0 parts of neopentylglycol, and 19.6 parts of trimellitic anhydride. The resin for pigment dispersion had an acid value of 40 mg KOH/g, a hydroxyl value of 108 mg KOH/g, and a number average molecular weight of 1,500.

### Production of Aqueous Second Colored Coating Composition

### Production Example 18

### Production of Acrylic Resin Emulsion (AC)

130 parts of deionized water and 0.52 parts of Aqualon KH-10 (Note 5) were added to a reaction vessel equipped with a thermometer, a thermostat, a stirrer, a reflux condenser, a nitrogen inlet tube, and a dropper, and mixed while stirring under a stream of nitrogen. The temperature was raised to 80° C.

Subsequently, 1% of the total amount of monomer emulsion (1) described below and 5.3 parts of a 6% ammonium persulfate aqueous solution were introduced into the reaction vessel, and allowed to stand at 80° C. for 15 minutes. The remaining monomer emulsion (1) was then added dropwise to the reaction vessel over a period of 3 hours, while maintaining the reaction vessel at the same temperature. After completion of the dropwise addition, the mixture was aged for 1 hour.

Subsequently, monomer emulsion (2) described below was added dropwise over a period of 1 hour, and the resulting mixture was aged for 1 hour. While 40 parts of a 5% aqueous dimethylethanolamine solution was gradually added to the reaction vessel, the mixture was cooled to 30° C. The mixture was filtered through a 100-mesh nylon cloth to obtain an acrylic resin emulsion (AC) having a solids content of 30%. The resulting acrylic resin had an acid value of 33 mg KOH/g and a hydroxyl value of 25 mg KOH/g.

(Note 5) Aqualon KH-10: a polyoxyethylene alkyl ether sulfate ester ammonium salt produced by Dai-ichi Kogyo Seiyaku Co., Ltd., active ingredient: 97%.
Monomer emulsion (1): an emulsion of 42 parts of deionized water, 0.72 parts of Aqualon KH-10, 2.1 parts of methylene bisacrylamide, 2.8 parts of styrene, 16.1 parts of methyl methacrylate, 28 parts of ethyl acrylate, and 21 parts of n-butyl acrylate.
Monomer emulsion (2): an emulsion of 18 parts of deionized water, 0.31 parts of Aqualon KH-10, 0.03 parts of ammonium persulfate, 5.1 parts of methacrylic acid, 5.1 parts of 2-hydroxyethyl acrylate, 3 parts of styrene, 6 parts of methyl methacrylate, 1.8 parts of ethyl acrylate, and 9 parts of n-butyl acrylate.

### Production Example 19

### Production of Polyester Resin Solution (PE2)

A reaction vessel equipped with a thermometer, a thermostat, a stirrer, a reflux condenser, and a water separator was charged with 109 parts of trimethylolpropane, 141 parts of 1,6-hexanediol, 126 parts of hexahydrophthalic anhydride, and 120 parts of adipic acid. After the temperature was raised from 160° C. to 230° C. over a period of 3 hours, the mixture was subjected to a condensation reaction at 230° C. for 4 hours. To add carboxyl groups to the resulting condensation reaction product, 38.3 parts of trimellitic anhydride was added, and the mixture was reacted at 170° C. for 30 minutes. The reaction mixture was then diluted with 2-ethyl-1-hexanol to obtain polyester resin solution (PE2) having a solids content of 70%. The resulting polyester resin had an acid value of 46 mg KOH/g, a hydroxyl value of 150 mg KOH/g, and a weight average molecular weight of 6,400.

### Production Example 20

### Production Example of Luster Pigment Dispersion (P1)

19 parts of an aluminium pigment paste (trade name “GX-180A”, produced by Asahi Kasei Metals Limited, metal content: 74%), 35 parts of 2-ethyl-1-hexanol, 8 parts of a phosphoric acid group-containing resin solution (Note 6), and 0.2 parts of 2-(dimethylamino)ethanol were uniformly mixed in a stirring/mixing vessel to thereby obtain luster pigment dispersion (P1).

(Note 6) Phosphoric acid group-containing resin solution: a phosphoric acid group-containing resin solution with a solids content of 50%, obtained by reacting 25 parts of styrene, 27.5 parts of n-butyl methacrylate, 20 parts of branched higher alkyl acrylate (trade name “Isostearyl acrylate” produced by Osaka Organic Chemical Industry, Ltd.), 7.5 parts of 4-hydroxybutyl acrylate, 15 parts of a phosphoric acid group-containing polymerizable monomer (Note 7), and 12.5 parts of 2-methacryloyloxyethyl acid phosphate. The phosphoric acid group-containing resin had an acid value, based on the phosphoric acid group, of 83 mg KOH/g, a hydroxyl value of 29 mg KOH/g, and a weight average molecular weight of 10,000.
(Note 7) Phosphoric acid group-containing polymerizable monomer: a phosphoric acid group-containing polymerizable monomer solution with a solids content of 50%, obtained by reacting 57.5 parts of monobutylphosphoric acid and 42.5 parts of glycidyl methacrylate.

### Production Example 21

### Production of Aqueous Second Colored Coating Composition

100 parts of the acrylic resin emulsion (AC) obtained in Production Example 18, 57 parts of polyester resin solution (PE2) obtained in Production Example 19, 62 parts of luster pigment dispersion (P1) obtained in Production Example 20, and 37.5 parts of Cymel 325 (trade name of an imino group-containing methylated melamine resin, produced by Japan Cytec Industries, Inc., solids content: 80%) were uniformly mixed. Further, a polyacrylic acid thickener (trade name “Primal ASE-60”, produced by Rohm & Haas Co.), 10 parts of 2-ethyl-1-hexanol, and deionized water were added to obtain an aqueous second colored coating composition having a pH of 8.0, a solids content of 25%, and a viscosity of 40 seconds as measured by Ford cup No. 4 at 20° C.

### Production of Amino Group-Containing Modified Epoxy Resin (A)

### Production Example 22

### Production Example of Base Resin No. 7

A 2-liter flask equipped with a thermometer, a reflux condenser, and a stirrer was charged with 162 parts of Glyci-ale PP-300P (Note 1), 1,000 parts of jER828 EL (Note 3), 440 parts of bisphenol A, and 1.6 parts of tetrabutylammonium bromide. The mixture was allowed to react at 160° C. until the epoxy equivalent became 800.

Next, 375 parts of methyl isobutyl ketone, and 124 parts of diethylamine were added to the mixture, and then allowed to react at 100° C. for 4 hours. The solution of base resin No. 7, which was an amino group-containing modified epoxy resin with a resin solids content of 80%, was thus obtained.

The proportion of diepoxy compound (a11) to the components of epoxy resin (A1) was 10 mass %, and the equivalent ratio of ([amino groups in dialkyl amine (A2)]/[epoxy groups in epoxy resin (A1)]) was 0.85. The resulting base resin No. 7 had an amine value of 55 mg KOH/g, and a number average molecular weight of 2,100.

### Production Example 23

### Production Example of Base Resin No. 8

A 2-liter flask equipped with a thermometer, a reflux condenser, and a stirrer was charged with 340 parts of Glyci-ale BPP-350 (Note 2), 950 parts of jER828 EL (Note 3), 456 parts of bisphenol A, and 1.7 parts of tetrabutylammonium bromide. The mixture was allowed to react at 160° C. until the epoxy equivalent became 875.

Next, 470 parts of methyl isobutyl ketone, and 124 parts of diethylamine were added to the mixture, and then allowed to react at 100° C. for 4 hours. The solution of base resin No. 8, which was an amino group-containing modified epoxy resin with a resin solids content of 80%, was thus obtained.

The proportion of diepoxy compound (a11) to the components of epoxy resin (A1) was 19 mass %, and the equivalent ratio of ([amino groups in dialkyl amine (A2)]/[epoxy groups in epoxy resin (A1)]) was 0.85. The resulting base resin No. 8 had an amine value of 51 mg KOH/g, and a number average molecular weight of 2,300.

### Production Example 24

### Production Example of Base Resin No. 9

162 parts of Glyci-ale PP-300P (Note 1), 1,000 parts of jER828 EL (Note 3), 440 parts of bisphenol A, and 1.6 parts of tetrabutylammonium bromide were inserted into a 2-liter flask equipped with a thermometer, a reflux condenser, and a stirrer. The mixture was allowed to react at 160° C. until the epoxy equivalent became 800.

Next, 375 parts of methyl isobutyl ketone, and 110 parts of diethylamine were added to the mixture, and then allowed to react at 100° C. for 4 hours. The solution of base resin No. 9, which was an amino group-containing modified epoxy resin with a resin solids content of 80%, was thus obtained.

The proportion of diepoxy compound (a11) to the components of epoxy resin (A1) was 9 mass %, and the equivalent ratio of ([amino groups in dialkyl amine (A2)]/[epoxy groups in epoxy resin (A1)]) was 0.75. The resulting base resin No. 9 had an amine value of 49 mg KOH/g, and a number average molecular weight of 2,300.

### Production Example 25

### Production Example of Base Resin No. 10

162 parts of Glyci-ale PP-300P (Note 1), 1,000 parts of jER828 EL (Note 3), 440 parts of bisphenol A, and 1.6 parts of tetrabutylammonium bromide were inserted into a 2-liter flask equipped with a thermometer, a reflux condenser, and a stirrer. The mixture was allowed to react at 160° C. until the epoxy equivalent became 800.

Next, 445 parts of methyl isobutyl ketone, and 175 parts of diisopropylamine were added to the mixture, and then allowed to react at 100° C. for 4 hours. The solution of base resin No. 10, which was an amino group-containing modified epoxy resin having a resin solids content of 80%, was thus obtained.

The proportion of diepoxy compound (a11) to the components of epoxy resin (A1) was 10 mass %, and the equivalent ratio of ([amino groups in dialkyl amine (A2)]/[epoxy groups in epoxy resin (A1)]) was 0.88. The resulting base resin No. 10 had an amine value of 55 mg KOH/g, and a number average molecular weight of 2,200.

Table 3 shows the formulations and the characteristic values of base resins Nos. 7 to 10 obtained in Production Examples 22 to 25.

TABLE 3

| | | | | Production | Production | Production | Production |
|---|---|---|---|---|---|---|---|
| | | | | Example 22 | Example 23 | Example 24 | Example 25 |
| Base resin | | | | No. 7 | No. 8 | No. 9 | No. 10 |
| Formulation | (A1) | (a11) | Glyci-ale | 162 | | 162 | 162 |
| | | | PP-300P (Note 1) | | | | |
| | | | Glyci-ale | | 340 | | |
| | | | BPP-350 (Note 2) | | | | |
| | | (a12) | jER828EL (Note 3) | 1000 | 950 | 1000 | 1000 |
| | | (a13) | Bisphenol A | 440 | 456 | 440 | 440 |
| | | Catalyst | Tetrabutylammonium | 1.6 | 1.7 | 1.6 | 1.6 |
| | | | bromide | | | | |
| | | Solvent | Methyl isobutyl | 375 | 470 | 375 | 445 |
| | | | ketone | | | | |

| (A2) | Diethylamine | 124 | 124 | 110 | |
|---|---|---|---|---|---|
| | Diisopropylamine | | | | 175 |
| Amine compound | Diethanol amine | | | | |

Ketimine of
diethylenetriamine
with methyl
isobutyl ketone

| | | | | | |
|---|---|---|---|---|---|
| | Proportion of diepoxy compound (a11) to | 10.0 | 19.0 | 9.0 | 10.0 |
| | components | | | | |
| | Equivalent ratio of (amino groups in | 0.85 | 0.85 | 0.75 | 0.88 |
| | dialkyl amine (A2))/(epoxy groups in | | | | |
| | epoxy resin (A1)) | | | | |
| Characteristic | Amine value (mg KOH/g) | 55 | 51 | 49 | 55 |
| value | Number average molecular weight | 2100 | 2300 | 2300 | 2200 |

The numerals in the formulations are by parts.

(Note 1) Glyci-ale PP-300P: trade name of an epoxy resin (diepoxy compound (a11)) produced by Sanyo Chemical Industries, Ltd.; epoxy equivalent: 296; corresponding to compound (2).
(Note 2) Glyci-ale BPP-350: trade name of an epoxy resin (diepoxy compound (a11)) produced by Sanyo Chemical Industries, Ltd.; epoxy equivalent: 340; corresponding to compound (1).
(Note 3) jER828 EL: trade name of an epoxy resin (a12) produced by Japan Epoxy Resin; epoxy equivalent: 190; number average molecular weight: 380

### Production of Emulsion

### Production Example 26

### Production Example of Emulsion No. 7

87.5 parts (solids content: 70 parts) of base resin No. 7 obtained in Production Example 22, 37.5 parts (solids content: 30 parts) of the curing agent obtained in Production Example 7, and 13 parts of 10% acetic acid were mixed and uniformly stirred. Thereafter, 156 parts of deionized water was added dropwise over about 15 minutes with vigorous stirring to thereby obtain emulsion No. 7 with a solids content of 34%.

### Production Examples 27 to 29

### Production Examples of Emulsions Nos. 8 to 10

Emulsions Nos. 8 to 10 were obtained in the same manner as in Production Example 26 except that the formulations shown in Table 4 were used.

TABLE 4

| | | Production | Production | Production | Production |
|---|---|---|---|---|---|
| | | Example 26 | Example 27 | Example 28 | Example 29 |
| Emulsion | | No. 7 | No. 8 | No. 9 | No. 10 |
| Formulation | Base | 87.5 (70.0) | | | |
| | resin | | | | |
| | No. 7 | | | | |
| | Base | | 87.5 (70.0) | | |
| | resin | | | | |
| | No. 8 | | | | |
| | Base | | | 87.5 (70.0) | |
| | resin | | | | |
| | No. 9 | | | | |
| | Base | | | | 87.5 (70.0) |
| | resin | | | | |
| | No. 10 | | | | |
| | Curing | 37.5 (30.0) | 37.5 (30.0) | 37.5 (30.0) | 37.5 (30.0) |
| | agent | | | | |
| | 10% | 13 | 13 | 13 | 13 |
| | acetic | | | | |
| | acid | | | | |
| | Deionized | 156.0 | 156.0 | 156.0 | 156.0 |
| | water | | | | |

| | | | | |
|---|---|---|---|---|
| Emulsion | 294.0 (100.0) | 294.0 (100.0) | 294.0 (100.0) | 294.0 (100.0) |

The parenthesized numerals in the formulations denote the solids content.

### Production of Cationic Electrodeposition Coating Composition

### Example 1

294 parts (solids content: 100 parts) of emulsion No. 1 obtained in Production Example 8, 52.4 parts (solids content: 28.8 parts) of 55% pigment dispersion paste obtained in Production Example 15, and 294 parts of deionized water were added. Cationic electrodeposition coating composition No. 1 with a solids content of 20% was thus obtained.

### Examples 2 to 8 and Comparative Examples 1 and 2

Cationic electrodeposition coating compositions Nos. 2 to 10 were produced in the same manner as in Example 1, except that the formulations shown in Tables 5 and 6 were used.

TABLE 5

| | | Example | Example | Example | Example |
|---|---|---|---|---|---|
| | | 1 | 2 | 3 | 4 |
| Cationic electrodeposition | | No. 1 | No. 2 | No. 3 | No. 4 |
| coating composition | | | | | |
| Formulation | Emulsion | 294 (100) | | | |
| | No. 1 | | | | |
| | Emulsion | | 294 (100) | | |
| | No. 2 | | | | |
| | Emulsion | | | 294 (100) | |
| | No. 3 | | | | |
| | Emulsion | | | | 294 (100) |
| | No. 4 | | | | |
| | Pigment | 52.4 (28.8) | 52.4 (28.8) | 52.4 (28.8) | 52.4 (28.8) |
| | dispersion | | | | |
| | Paste | | | | |
| | Deionized | 297.6 | 297.6 | 297.6 | 297.6 |
| | water | | | | |

| | | | | |
|---|---|---|---|---|
| Cationic electrodeposition | 644 (128.8) | 644 (128.8) | 644 (128.8) | 644 (128.8) |
| coating composition | | | | |
| Solids content: 20% | | | | |

The numerals denote the amount of the ingredient used, and the parenthesized numerals denote the solids content.

TABLE 6

| | | | | | | Comp. | Comp. |
|---|---|---|---|---|---|---|---|
| | | Example | Example | Example | Example | Example | Example |
| | | 5 | 6 | 7 | 8 | 1 | 2 |
| Cationic electrodeposition | | No. 7 | No. 8 | No. 9 | No. 10 | No. 5 | No. 6 |
| coating composition | | | | | | | |
| Formulation | Emulsion | 294 (100) | | | | | |
| | No. 7 | | | | | | |
| | Emulsion | | 294 (100) | | | | |
| | No. 8 | | | | | | |
| | Emulsion | | | 294 (100) | | | |
| | No. 9 | | | | | | |
| | Emulsion | | | | 294 (100) | | |
| | No. 10 | | | | | | |
| | Emulsion | | | | | 294 (100) | |
| | No. 5 | | | | | | |
| | Emulsion | | | | | | 294 (100) |
| | No. 6 | | | | | | |
| | Pigment | 52.4 (28.8) | 52.4 (28.8) | 52.4 (28.8) | 52.4 (28.8) | 52.4 (28.8) | 52.4 (28.8) |
| | dispersion | | | | | | |
| | Paste | | | | | | |
| | Deionized | 297.6 | 297.6 | 297.6 | 297.6 | 297.6 | 297.6 |
| | water | | | | | | |

| | | | | | | |
|---|---|---|---|---|---|---|
| Cationic electrodeposition | 644 (128.8) | 644 (128.8) | 644 (128.8) | 644 (128.8) | 644 (128.8) | 644 (128.8) |
| coating composition | | | | | | |
| Solids content: 20% | | | | | | |

The numerals denote the amount of the ingredient used, and the parenthesized numerals denote the solids content.

### Preparation of Plate Comprising Cationic Electrodeposition Coating Film

Each of the cationic electrodeposition coating compositions obtained in the Examples and Comparative Examples was applied by electrodeposition to a cold-rolled steel sheet (150 mm (length)×70 mm (width)×0.8 mm (thickness); center line mean roughness (Ra): 0.8) treated by chemical conversion with Palbond #3020 (trade name of zinc phosphate treatment agent produced by Nihon Parkerizing Co., Ltd.) to a dried film thickness of 15 μm.

### Preparation of Test Plate Comprising a Multilayer Coating Film by 3C1B Process

Each of the cationic electrodeposition coating compositions was applied by electrodeposition to a cold-rolled steel sheet (150 mm (length)×70 mm (width)×0.8 mm (thickness); center line mean roughness (R^{a}): 0.8) treated by chemical conversion with Palbond #3020 (trade name of zinc phosphate treatment agent produced by Nihon Parkerizing Co., Ltd.). The resulting film was heated at 170° C. for 20 min., thereby obtaining a cured electrodepostion coating film with a cured film thickness of 20 μm.

The aqueous first colored coating composition obtained in Production Example 17 was electrostatically applied to the film to a cured film thickness of 25 μm. The resulting film was allowed to stand for 2 minutes, and pre-heated at 80° C. for 5 minutes.

Subsequently, the aqueous second colored coating composition obtained in Production Example 21 was electrostatically applied to the uncured first colored coating film, using a rotary electrostatic spray coater, to a cured film thickness of 15 μm. The resulting film was allowed to stand for 2 minutes, and pre-heated at 80° C. for 5 minutes.

Next, KNOW1200T (trade name of a clear coating composition produced by Kansai Paint Co., Ltd.) was electrostatically applied to the aqueous second colored coating film to a cured film thickness of 35 μm, and allowed to stand for 7 minutes. Subsequently, the aqueous first colored coating film, aqueous second colored coating film, and clear coating film were cured by heating at 140° C. for 30 minutes. A test plate comprising the multilayer coating film obtained by the 3C1B process was thus obtained.

Tables 7 and 8 show the results of tests conducted using the obtained “test plates comprising a cationic electrodeposition coating film” and “test plates comprising a multilayer coating film obtained by the 3C1B process”.

TABLE 7

| | | | | | | | Comp. | Comp. |
|---|---|---|---|---|---|---|---|---|
| | | | Ex. 1 | Ex. 2 | Ex. 3 | Ex. 4 | Ex. 1 | Ex. 2 |
| Cationic electorodeposition coating composition | | | No. 1 | No. 2 | No. 3 | No. 4 | No. 5 | No. 6 |
| Single-layer | Throwing power | Surface G | 10 | 10 | 10 | 10 | 8 | 10 |
| electrodeposition | (Note 8) | (μm) | | | | | | |
| coating film | | Surface A | 15 | 15 | 15 | 15 | 15 | 15 |
| | | (μm) | | | | | | |
| | | % | 67 | 67 | 67 | 67 | 53 | 67 |
| | Electrodeposition coating | | B | B | B | B | B | B |
| | applicability onto hot dip | | | | | | | |
| | galvanized steel sheets | | | | | | | |
| | (Note 9) | | | | | | | |
| | Surface roughness of | Ra | B | B | B | B | B | C |
| | electrodeposition | | | | | | | |
| | coating film | | | | | | | |
| | (Note 10) | | | | | | | |

| | | | | | | |
|---|---|---|---|---|---|---|
| Anti-corrosion properties | B | B | B | B | B | B |
| (Note 11) | | | | | | |

| | | | | | | |
|---|---|---|---|---|---|---|
| Finish of multilayer coating film (Note 12) | B | B | B | B | B | C |
| Comprehensive evaluation | B | B | B | B | C | C |

TABLE 8

| | | | | | | | Comp. | Comp. |
|---|---|---|---|---|---|---|---|---|
| | | | Ex. 5 | Ex. 6 | Ex. 7 | Ex. 8 | Ex. 1 | Ex. 2 |
| Cationic electorodeposition coating composition | | | No. 7 | No. 8 | No. 9 | No. 10 | No. 5 | No. 6 |
| Single-layer | Throwing power | Surface G | 11 | 10 | 11 | 10 | 8 | 10 |
| electrodeposition | (Note 8) | (μm) | | | | | | |
| coating film | | Surface A | 15 | 15 | 15 | 15 | 15 | 15 |
| | | (μm) | | | | | | |
| | | % | 73 | 67 | 73 | 67 | 53 | 67 |
| | Electrodeposition coating | | A | B | B | B | B | B |
| | applicability onto hot dip | | | | | | | |
| | galvanized steel sheets | | | | | | | |
| | (Note 9) | | | | | | | |
| | Surface roughness of | Ra | A | B | B | B | B | C |
| | electrodeposition | | | | | | | |
| | coating film | | | | | | | |
| | (Note 10) | | | | | | | |

| | | | | | | |
|---|---|---|---|---|---|---|
| Anti-corrosion properties | B | A | B | B | B | A |
| (Note 11) | | | | | | |

| | | | | | | |
|---|---|---|---|---|---|---|
| Finish of multilayer coating film (Note 12) | A | B | B | B | B | C |
| Comprehensive evaluation | A | A | B | B | C | C |

### Note 8: Throwing Power

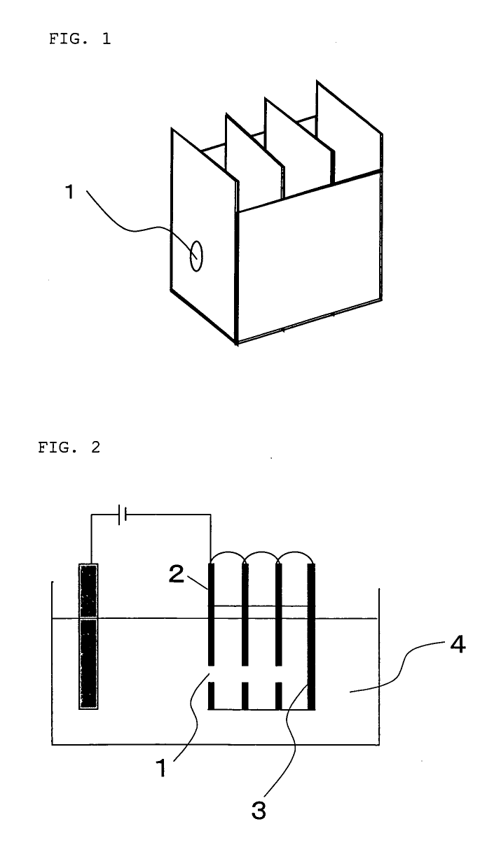

In a four-sheet box for throwing power evaluation (see FIG. 1), holes that were 8 mm in diameter were made, and four steel sheets positioned with an interval of 2 cm were connected as shown in FIG. 2.

Of the four steel sheets shown in FIG. 2, the left surface of the outermost left steel sheet was called “surface A” and the right surface was called “surface B”. Similarly, the left and right surfaces of the second steel sheet from the left were called “surface C” and “surface D”, respectively; the left and right surfaces of the third steel sheet from the left were called “surface E” and “surface F”, respectively; and the left and right surfaces of the outermost right steel sheet were called “surface G” and “surface H”, respectively. Of these, the surface A was referred to as the outer surface and the surface G was referred to as the inner surface.

Electrodeposition coating was performed on the device shown in FIG. 2 under the following conditions: coating bath temperature: 30° C.; distance between surface A and the electrode: 10 cm; time for applying current: 3 minutes. The voltage was adjusted so that the dried thickness of the coating film on the outer surface became 15 μm. Throwing power were evaluated based on the dried thickness of the coating films on the outer surface and the inner surface, and the amount of deposition (%). Amount of deposition (%)=(dried thickness of the coating film on the inner surface/dried thickness of the coating film on the outer surface×100).

Note 9: Electrodeposition Coating Applicability onto Hot Dip Galvanized Steel Sheets

An alloyed hot dip galvanized steel sheet (0.8 mm×150 mm×70 mm) treated by chemical conversion with Palbond #3020 (trade name of a zinc phosphate treatment agent produced by Nihon Parkerizing Co., Ltd.) was immersed for use as a cathode in a bath containing an electrodeposition coating composition (30° C.). Electrodeposition coating was performed by adjusting the current application time at a voltage of 210V, thereby obtaining a 15 μm coating film. The number of pinholes was counted in 10×10 cm of the test piece obtained by heat-curing the resulting coating film at 170° C. for 20 minutes. Electrodeposition coating applicability onto hot dip galvanized steel sheets was evaluated according to the following criteria:

A: No pinhole.
B: One small pinhole (gas pinhole) was observed; however, since the pinhole was small enough to be sealed by an intermediate coating film, there were no problems.
C: 2 to 5 pinholes.
D: 10 or more pinholes.

### Note 10: Surface Roughness of Electrodeposition Coating Film

The center line mean roughness (Ra) of each of the electrodeposition coating films (dried film thickness: 15 μm) obtained in the Examples and Comparative Examples was measured using Surfcom 301 (trade name of a surface roughness measuring instrument produced by Mitsutoyo Corporation) according to JIS B 0601 (Definition and Indication of Surface Roughness, 1982). The surface roughness of each of the electrodeposition coating films was evaluated by “center line mean roughness (Ra)” according to the following criteria:

A: Ra was less than 0.20.
B: Ra was not less than 0.20 and less than 0.50.
C: Ra was not less than 0.50 and less than 0.70.
D: Ra was not less than 0.70.

### Note 11: Anti-Corrosion Properties

A cold-rolled steel sheet (0.8 mm×150 mm×70 mm) treated by chemical conversion with Palbond #3020 (trade name of a zinc phosphate treatment agent produced by Nihon Parkerizing Co., Ltd.) was immersed in each of the cationic electrodeposition coating compositions to proceed electrodeposition coating.

Subsequently, the resultant was baked at 170° C. for 20 min to thereby obtain a test plate having a dried film thickness of 15 μm. The test plate was cross-cut with a knife so that the cut reached the substrate. The test plate was then subjected to a salt spray test at 35° C. for 840 hours in accordance with JIS Z-2371. Anti-corrosion properties were rated based on the width of rust or blister resulting from the cut portion according to the following criteria:

A: The maximum width of rust or blister resulting from the cut was not more than 2.0 mm (on one side).
B: The maximum width of rust or blister resulting from the cut was more than 2.0 mm and not more than 3.0 mm (on one side).
C: The maximum width of rust or blister resulting from the cut was more than 3.0 mm and not more than 3.5 mm (on one side).
D: The maximum width of rust or blister resulting from the cut was more than 3.5 mm (on one side).

### Note 12: Finish of Multilayer Coating Film Obtained by 3C1B Process

Each of the multilayer coating films obtained in the section “Preparation of test plate comprising a multilayer coating film by 3C1B process” above was evaluated based on the Wb value measured by “Wave Scan DOI” (trade name, BYK Gardner). The smaller the measured value, the smoother the coating surface. The finish of the multilayer coating film was evaluated according to the following criteria.

A: Wb was less than 15.
B: Wb was not less than 15 and less than 20.
C: Wb was not less than 20 and less than 25.
D: Wb was not less than 25.

### Comprehensive Evaluation:

In the field of cationic electrodeposition coating compositions to which the present invention belongs, it is extremely important that compositions excel in terms of five properties, i.e., throwing power, electrodeposition coating applicability onto hot dip galvanized steel sheets; surface roughness of the electrodeposition coating film; anti-corrosion properties; and the finish of a multilayer coating film. Hence, each of the cationic electrodeposition coating compositions was comprehensively evaluated according to the following criteria:

A: The amount of deposition was at least 60%, and the other four properties were rated as either A or B (including at least one A).
B: The amount of deposition was at least 60%, and the other four properties were all rated as B.
C: The amount of deposition was at least 50% and less than 60%, and the other four properties were rated as A, B, or C; or the other four properties were rated as A, B or C (including at least one C).
D: The amount of deposition was less than 50%; or of the other four properties, at least one property was rated as D.

### INDUSTRIAL APPLICABILITY

The present invention provides a coating composition that has excellent throwing power and electrodeposition coating applicability onto hot dip galvanized steel sheets, and that provides a cationic electrodeposition coating film with an excellent finish, and a multilayer coating film with an excellent finish formed on the cationic electrodeposition coating film by a 3C1B process.

### EXPLANATION OF NUMERALS

1. Hole (8 mm in diameter) on the outer surface (surface A) of the four-sheet box for throwing power evaluation.
2. Outer surface (surface A) of the four-sheet box for throwing power evaluation.
3. Inner surface (surface G) of the four-sheet box for throwing power evaluation.
4. Bath containing the electrodeposition coating composition.

1. A cationic electrodeposition coating composition comprising:
amino group-containing epoxy resin (A) obtained by reacting epoxy resin (A1) having an epoxy equivalent of 500 to 2,500 with amine compound (A2) represented by formula (I) 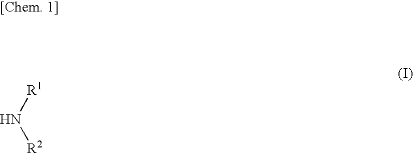
wherein R¹ represents a C₁₋₈ alkyl group, and R² represents a C₂₋₈ alkyl group optionally having at least one hydroxyl group; and
blocked polyisocyanate curing agent (B).

2. The cationic electrodeposition coating composition according to claim 1, wherein, in the formula (I), R¹ represents a C₁₋₆ alkyl group, and R² represents a C₂₋₈ alkyl group having a hydroxyl group; or R¹ and R² are the same or different, and each represents a C₂₋₈ alkyl group.

3. The cationic electrodeposition coating composition according to claim 1, wherein, in the formula (I), R¹ represents a C₁₋₆ alkyl group, and R² represents a C₂₋₈ alkyl group having a hydroxyl group.

4. The cationic electrodeposition coating composition according to claim 1, wherein amino group-containing epoxy resin (A) is obtainable by reacting epoxy resin (A1) and amine compound (A2) at an equivalent ratio of (amino groups in amine compound (A2))/(epoxy groups in epoxy resin (A1)) being 0.6 to 0.95.

5. The cationic electrodeposition coating composition according to claim 1, wherein epoxy resin (A1) is obtainable by reacting (a11), (a12), and (a13) below: said (a11) being compound (1) represented by formula (1) 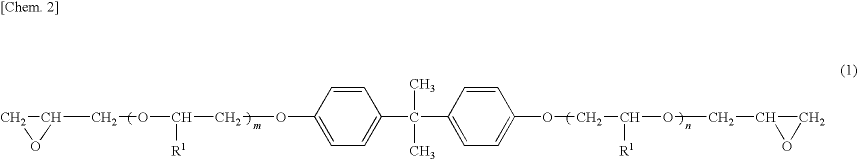
wherein R¹s are the same or different, and each represents a hydrogen atom or C₁₋₆ alkyl group;
and m and n, which represent the number of repeating units of a portion having an alkylene oxide structure, are integers where m+n=1 to 20, and/or
compound (2) represented by formula (2) 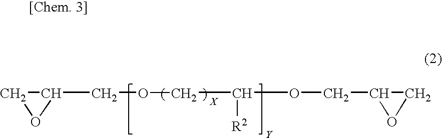
wherein R²s are the same or different, and each represents a hydrogen atom or C₁₋₆ alkyl group;
X represents an integer of 1 to 9; and Y represents an integer of 1 to 50;
said (a12) being an epoxy resin having an epoxy equivalent of 170 to 500; and
said (a13) being a bisphenol compound.

6. The cationic electrodeposition coating composition according to claim 5, wherein epoxy resin (A1) is obtainable by reacting 1 to 35 mass % of diepoxy compound (a11), 10 to 80 mass % of epoxy resin (a12), and 10 to 60 mass % of bisphenol compound (a13), based on the total solids mass of said diepoxy compound (a11), epoxy resin (a12), and bisphenol compound (a13).

7. The cationic electrodeposition coating composition according to claim 5, wherein diepoxy compound (a11) is a compound in which R¹ in formula (1) or (2) represents a methyl group or a hydrogen atom.

8. A coated article obtained by immersing a metal article containing a hot dip galvanized steel sheet in an electrodeposition bath containing the cationic electrodeposition coating composition according to claim 1, and performing electrodeposition coating.

9. The cationic electrodeposition coating composition according to claim 2, wherein epoxy resin (A1) is obtainable by reacting (a11), (a12), and (a13) below:
said (a11) being compound (1) represented by formula (1) 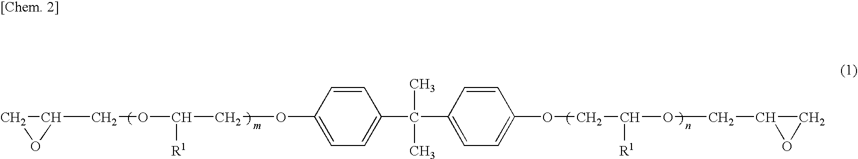
wherein R¹s are the same or different, and each represents a hydrogen atom or C₁₋₆ alkyl group;
and m and n, which represent the number of repeating units of a portion having an alkylene oxide structure, are integers where m+n=1 to 20, and/or
compound (2) represented by formula (2) 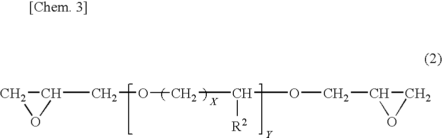
wherein R²s are the same or different, and each represents a hydrogen atom or C₁₋₆ alkyl group;
X represents an integer of 1 to 9; and Y represents an integer of 1 to 50;
said (a12) being an epoxy resin having an epoxy equivalent of 170 to 500; and
said (a13) being a bisphenol compound.

10. The cationic electrodeposition coating composition according to claim 3, wherein epoxy resin (A1) is obtainable by reacting (a11), (a12), and (a13) below:
said (a11) being compound (1) represented by formula (1) 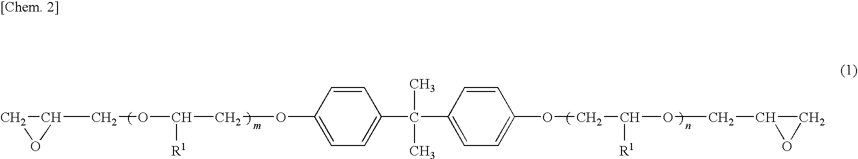
wherein R¹s are the same or different, and each represents a hydrogen atom or C₁₋₆ alkyl group;
and m and n, which represent the number of repeating units of a portion having an alkylene oxide structure, are integers where m+n=1 to 20, and/or
compound (2) represented by formula (2) 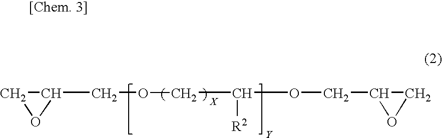
wherein R²s are the same or different, and each represents a hydrogen atom or C₁₋₆ alkyl group;
X represents an integer of 1 to 9; and Y represents an integer of 1 to 50;
said (a12) being an epoxy resin having an epoxy equivalent of 170 to 500; and
said (a13) being a bisphenol compound.

11. The cationic electrodeposition coating composition according to claim 6, wherein diepoxy compound (a11) is a compound in which R¹ in formula (1) or (2) represents a methyl group or a hydrogen atom.
